(19) United States
(12) Patent Application Publication
(10) Pub. No.: US 2016/0226111 A1
(43) Pub. Date: Aug. 4, 2016

(54) THERMAL MANAGEMENT SYSTEMS AND BATTERY PACKS INCLUDING THE SAME

(71) Applicant: Prodigy Aircraft LLC, Orem, UT (US)

(72) Inventors: Zachary Dennis Blume, Orem, UT (US); Aaron Amold Patey, Elk Ridge, UT (US)

(73) Assignee: Prodigy Aircraft LLC, Orem, UT (US)

(21) Appl. No.: 14/610,778

(22) Filed: Jan. 30, 2015

(51) Int. Cl. H01M 10/637; H01M 10/625; H01M 10/613

(52) U.S. Cl. CPC H01M 10/637; H01M 10/613; H01M 10/625

(57) ABSTRACT

The thermal management system disclosed herein includes a first heat exchanger, a second heat exchanger, and a thermoelectric pad. The thermoelectric pad is positioned such that it is in thermal contact with the first heat exchanger and the second heat exchanger. The thermoelectric pad may therefore be positioned between the first heat exchanger and the second heat exchanger to both heat and cool a substrate as desired.

### PRIORITY CLAIM

This application claims priority to U.S. Provisional Application 61/933,324, filed on Jan. 30, 2014, which is incorporated herein by reference.

### BACKGROUND

1. Technical Field

A system disclosed herein generally relates to managing a temperature of one or more substrates. More specifically. the system disclosed herein relates to a system to control thermal energy within a closed battery system.

2. Description of the Related Art

Batteries are devices that store electrical charge for a period of time. Some batteries are rechargeable when at least a portion of the electrical charge in the batteries is expended. The time during which battery life may be expended and recharged is known more commonly as “battery life.” Recent advances in battery technology have substantially lengthened battery life and the ability of the battery to maintain an electrical charge and recharge. However, these same advances have made batteries more susceptible to environmental changes such as battery temperature, humidity surrounding the battery, and many other factors.

These environmental changes are more pronounced when the changes are extreme. For example, extremely hot and extremely cold temperatures have a pronounced effect on the ability of a battery to maintain a charge over the useable life of the battery. These environmental effects are only further exacerbated when batteries are used in vehicles, for example, which may be subject to extremely hot and extremely cold temperatures. An automobile battery, for example, may be subject to very low temperatures in a cold weather climate and may be subject to very high temperatures in a warm weather climate. Similarly, other vehicles such as airplanes experience extreme cold in flight and relative warmth when on the ground.

Conventional systems fail, however, to maintain an optimal temperature in a battery exposed to extreme heat or extreme cold. In one embodiment, of this disclosure, a system to maintain an optimal temperature in a battery exposed to extreme heat or extreme cold is provided.

Conventional systems also fail to maintain a dry environment for a battery that is used outdoors. For example, vehicles are frequently exposed to humid or wet conditions. In another embodiment of this disclosure, a system to maintain a substantially dry battery environment is provided.

### SUMMARY

Consistent with embodiments disclosed herein, a thermal management system is disclosed. The thermal management system includes a first heat exchanger, a second heat exchanger, and a thermoelectric pad. The thermoelectric pad is positioned such that it is in thermal contact with the first heat exchanger and the second heat exchanger. The thermoelectric pad may therefore be positioned between the first heat exchanger and the second heat exchanger.

In another implementation, a thermal management system is disclosed. The thermal management system includes a first heat exchanger disposed within a housing, a second heat exchanger disposed within the housing, a thermoelectric pad in thermal contact with the first heat exchanger and the second heat exchanger and positioned between the first heat exchanger and the second heat exchanger within the housing. The thermal management system also includes a substrate within the housing. The temperature of the housing is controlled by a thermal management system controller applying electric current to the thermoelectric pad.

It is to be understood that both the foregoing general description and the following detailed description are exemplary and explanatory only and do not restrict the scope of the claims.

### BRIEF DESCRIPTION OF THE DRAWINGS

The accompanying drawings illustrate several embodiments of the thermal management system disclosed herein and constitute a part of the specification. The illustrated embodiments are exemplary and do not limit the scope of the disclosure.

FIG. 1 illustrates a thermal management system for controlling the temperature of a closed system.

FIG. 2 illustrates a process for cooling a battery subjected to extreme heat to an optimal temperature using the thermal management system.

FIG. 3 illustrates a process for warming a battery subjected to extreme cold to an optimal temperature using the thermal management system.

FIG. 4 illustrates a process for removing humidity from a battery pack.

### DETAILED DESCRIPTION OF PREFERRED EMBODIMENTS

In the following description, for purposes of explanation and not limitation, specific techniques and embodiments are set forth, such as particular techniques and configurations. in order to provide a thorough understanding of the device disclosed herein. While the techniques and embodiments will primarily be described in context with the accompanying drawings, those skilled in the art will further appreciate that the techniques and embodiments may also be practiced in other similar devices.

Reference will now be made in detail to the exemplary embodiments, examples of which are illustrated in the accompanying drawings. Wherever possible, the same reference numbers are used throughout the drawings to refer to the same or like parts. It is further noted that elements disclosed with respect to particular embodiments are not restricted to only those embodiments in which they are described. For example, an element described in reference to one embodiment or figure, may be alternatively included in another embodiment or figure regardless of whether or not those elements are shown or described in another embodiment or figure. In other words, elements in the figures may be interchangeable between various embodiments disclosed herein, whether or not shown in the accompanying figures.

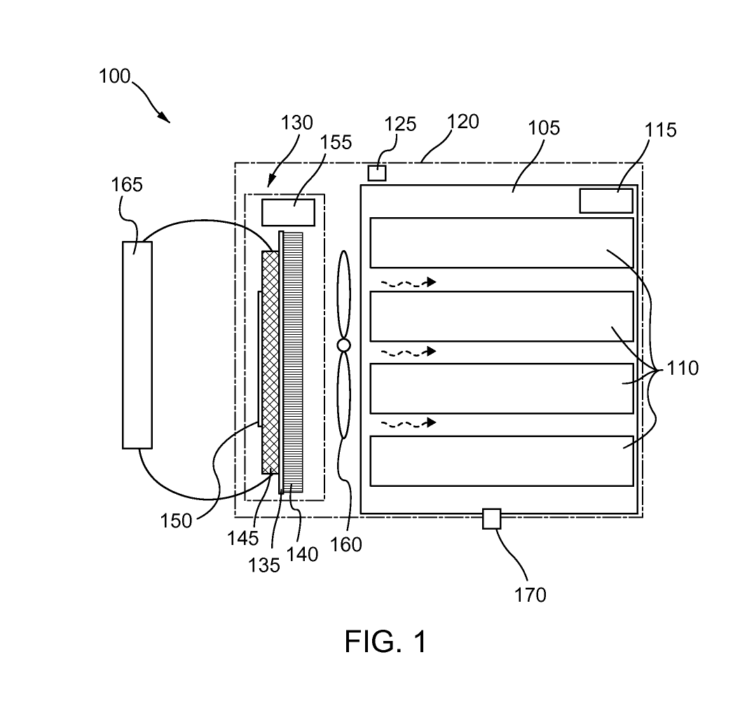

FIG. 1 illustrates a thermal management system for controlling the temperature of a closed system 100. In FIG. 1, closed system 100 is a battery pack containing a frame 105, one or more batteries 110, a battery controller 115, all disposed within a housing 120. The battery pack further includes one or more sensors 125 communicatively coupled to a thermal management system 130. Thermal management system 130 includes a thermoelectric pad 135, a first heat exchanger 140, a second heat exchanger 145, a thermal management system controller 150, and a temperature receiver 155. Also included in closed system 100 is a fan 160, a thermal unit 165, and a one way valve 170 disposed within housing 120.

While FIG. 1 shows one embodiment of closed system 100 that includes batteries, any substrate can be kept at an optimal temperature in a closed system, or alternately stated, a sealed environment, using thermal management system 130. As used herein a substrate can be any material that is temperature sensitive or that can be made more efficient, useful, or cost effective through the application of heat or the removal of heat from the substrate. There are other embodiments in which aspects of this disclosure could be used in an open system, a system that does not contain a sealed environment or a system that is semi-sealed. However, aspects of this disclosure incorporated into an open system would be substantially less efficient in an open environment or a semi-sealed environment. In one embodiment, closed system 100 is substantially waterproof. For example, closed system 100 may be impenetrable to water at an IP-67 rating of the International Electrotechnical Commission standard 60529.

As shown in FIG. 1, one or more batteries 110 are disposed within frame 105 of housing 120 within closed system 100. The number and size of batteries included within closed system 100 may vary based on the size limitations or power needs of a particular application. Thus, while four batteries are shown in FIG. 1, any number of batteries can be implemented within closed system 100. Frame 105 and housing 120 of closed system 100 provide rigid support for one or more batteries 110 that are disposed therein. Frame 105 and housing 120 also provide rigid support for battery controller 115.

Battery controller 115 may include a battery control module that provides an interface to a controller or sensors in a vehicle. In one simple example, battery controller 115 may interface with an electronic command module within a vehicle and provide information about one or more batteries 110 such as level of charge, voltage, amperage, and any other battery characteristic. Battery controller 115 may interface with a controller or sensors in a vehicle using a controller area network (“CAN”). The CAN is typically implemented in the vehicle by a CAN bus or TWI serial communication. However, battery controller 115 may be configured to communicate with the vehicle using any network connection, wired or wireless.

FIG. 1 further includes one or more sensors 125 that detect one or more environmental conditions within closed system 100. For example, one or more sensors 125 may detect a temperature within closed system 100, a temperature of the one or more batteries 110, a humidity level within closed system 100, a rate of cooling within closed system 100, a rate of heating within closed system 100, voltages, power consumption, and any other condition that may have an effect on the manner in which closed system 100 is heated or cooled.

Thermal management system 130 is disposed within closed system 100 to control and manipulate the environment within closed system 100. Thermal management system 130 includes thermoelectric pad 135 which is disposed between first heat exchanger 140 and second heat exchanger 145. First heat exchanger 140 is typically made of a metal or metal alloy conducive to the conduction of heat, examples of which include graphene, silver, copper, gold, aluminum, tungsten, zinc, nickel, iron, tin, and any alloy, amalgam, plating, or bond of these metals. First heat exchanger 140 includes one or more heat sink fins that increase the surface area, and therefore the thermal response, of first heat exchanger 140. Second heat exchanger 145 may also be referred to as a water block. Second heat exchanger 145 may also be made of one of the previously discussed metal or metal alloys conducive to the conduction of heat and include a heat sink which may be implemented with heat sink fins or be arranged in the shape of a honeycomb within second heat exchanger 145. A thermal liquid may be contained within second heat exchanger 145 and reside in thermal contact with the heat sink within second heat exchanger 145. Thermal fluids include fluids that easily absorb and dissipate heat such as water, ethylene glycol, a mixture of ethylene glycol and water, methanol (methyl alcohol), propylene glycol, glycerol, or any other chemical compound with similar thermal properties. First heat exchanger 140 and second heat exchanger 145 are configured such that the respective abilities of first heat exchanger 140 and second heat exchanger 145 to conduct heat are substantially equal. In other words, in at least one embodiment, first heat exchanger 140 and second heat exchanger 145 may have substantially the same mass, substantially the same surface area, be made of substantially the same metal or metal alloy, and generally share the same ability to conduct, radiate, or dissipate heat.

Thermoelectric pad 135 provides for the conduction of heat between first heat exchanger 140 and second heat exchanger 145. For example, thermoelectric pad 135 may include semiconductors that are disposed in a thermal substrate, such as, for example, a ceramic substrate. When an electrical current is applied to the semiconductors in thermoelectric pad 135, a temperature differential occurs between each side of thermoelectric pad 135. As electrically excited electrons flow from one side of thermoelectric pad 135 to the opposite side of thermoelectric pad 135, one side of thermoelectric pad 135 cools while the opposite side of thermoelectric pad 135 warms. In this way, thermal management system controller 150 can conduct heat into closed system 100 and dissipate heat from closed system 100 merely by changing the direction of current flow through thermoelectric pad 135, as will be discussed in more detail below.

Thermal management system 130 further includes thermal management system controller 150. Thermal management system controller 150 can include a combination of one or more application programs and one or more hardware components configured to manipulate the internal temperature of closed system 100. For example, application programs may include software modules, sequences of instructions, routines, data structures, display interfaces, and other types of structures that execute computer operations. Further, hardware components may include a combination of Central Processing Units (“CPUs”), buses, volatile and non-volatile memory devices, storage units, non-transitory computer-readable media, data processors, processing devices, control devices transmitters, receivers, antennas, transceivers, input devices, output devices, network interface devices, and other types of components that are apparent to those skilled in the art. Thermal management system controller 150 is configured to interface with temperature receiver 155. Temperature receiver 155 receives temperature information for one or more of batteries 110 and communicates that temperature information to thermal management system controller 150. Depending on the temperature information, thermal management system controller 150 may apply heat within closed system 100 or dissipate heat from closed system 100.

Thermal management system controller 150 may control fan 160 that circulates heated or cooled air throughout closed system 100. As the air circulates to cool closed system 100, heat is conducted from first heat exchanger 140 to second heat exchanger 145 through thermoelectric pad 135 and to thermal unit 165 which contains a thermal fluid that absorbs heat from second heat exchanger 145 and dissipates it. As the air circulates to warm closed system 100, heat within the thermal fluid of thermal unit 165 is conducted to second heat exchanger 145 and to first heat exchanger 140 through thermoelectric pad 135 which radiates heat into closed system 100.

While several implementations of this system are possible, the system will now be described, in an exemplary and non-limiting fashion, in the context of a hybrid automobile, an automobile that is configured to operate using both power derived from a combustion engine and battery power together or independently. In this example, a hybrid automobile is parked in a hot environment. In this example, the hybrid automobile may be subjected to temperatures in excess of 100 degrees Fahrenheit during hot weather that is experienced by much of the United States during summer. Thus, the hot weather heats the car and all of the internal components, such as a hybrid automobile battery pack similar to closed system 100 shown in FIG. 1. As a result, the hybrid automobile battery pack experiences a temperature that is above the optimal temperature range for the battery pack, which has an adverse effect on the battery. In one embodiment, the optimal temperature range for the battery pack is between 35 and 80 degrees Fahrenheit and preferably within a range of 5-15 degrees Celsius (41-59 degrees Fahrenheit).

Continuing with the exemplary description of the automobile battery pack similar to closed system 100 shown in FIG. 1, when a driver turns the key in the hybrid automobile, thermal management system 130 detects, via thermal management system controller 150 and temperature receiver 155, that the temperature of dosed system 100 exceeds an optimal temperature for battery operation and battery life. Thermal management system controller 150 then initiates a cooling sequence for closed system 100. In this example, heat must be removed from closed system 100. In order to remove the heat, electric current is provided to thermoelectric pad 135 in a direction that cools a first side of thermoelectric pad 135 that is positioned to be in thermal contact with first heat exchanger 140. Heat from closed system 100 is absorbed through heat sink fins of first heat exchanger 140 and conducted to the cooled first side of thermoelectric pad 135. This heat is conducted through thermoelectric pad 135 to a second side of thermoelectric pad 135 that is positioned to be in thermal contact with second heat exchanger 145. In this manner, heat is radiated through the second side of thermoelectric pad 135 into second heat exchanger 145. A thermal fluid within second heat exchanger 145 is pumped through second heat exchanger 145 and into thermal unit 165. In this example, a radiator in the hybrid automobile may serve as thermal unit 165. As the user drives the hybrid automobile, heat transferred into the thermal liquid through second heat exchanger 145 is radiated away from the hybrid automobile by the radiator of the hybrid automobile and rejected into the air flowing around the hybrid automobile. Fan 160 may be used to circulate air that has been cooled by the removal of heat through the heat sink fins of first heat exchanger 140 throughout closed system 100.

In this manner, heat introduced into closed system 100 while the hybrid automobile is parked, may be conducted out of closed system 100 and away from the battery pack. Thermal management system controller 150 continuously receives temperature information for one or more batteries 110 via temperature receiver 155. Once the temperature of one or more batteries 110 within closed system 100 is brought into an optimal range, thermal management system controller 150 adjusts the electric current level applied to thermoelectric pad 135 in order to maintain an optimal temperature environment within closed system 100.

In another example, a hybrid automobile is parked in a cold environment. In this example, the hybrid automobile may be subjected to temperatures lower than 0 degrees Fahrenheit during cold weather that is experienced by much of the United States during winter. Thus, the cold weather cools the car and all of the internal components, such as a hybrid automobile battery pack that is similar to closed system 100 shown in FIG. 1. As a result, the hybrid automobile battery pack experiences a temperature that is below the optimal temperature range for the battery pack, which has an adverse effect on the battery. In one embodiment, the optimal temperature range for the battery pack is between 35 and 80 degrees Fahrenheit and preferably within a range of 5-15 degrees Celsius (41-59 degrees Fahrenheit).

Continuing with the exemplary description of the automobile battery pack which is similar to closed system 100 as shown in FIG. 1, when a driver turns a keyed ignition in the hybrid automobile, thermal management system 130 detects, via thermal management system controller 150 and temperature receiver 155, that the temperature of closed system 100 is lower than an optimal temperature for battery operation and battery life. Thermal management system controller 150 then initiates a heating sequence for closed system 100. In this example, heat must be introduced into closed system 100. In order to introduce heat, current is provided to thermoelectric pad 135 that cools a second side of thermoelectric pad 135 that is positioned to be in thermal contact with second heat exchanger 145. Thermal unit 165 may absorb heat into a thermal liquid contained within thermal unit 165. In one embodiment, heat may be generated by a combustion engine operating within the hybrid automobile. The thermal liquid is pumped from thermal unit 165 through second heat exchanger 145. As the second side of thermoelectric pad 135 cools, and because thermoelectric pad 135 is in thermal contact with second heat exchanger 145, heat from the thermal liquid is conducted into second heat exchanger 145 and then to thermoelectric pad 135. As heat is introduced to the second side of thermoelectric pad 135 which has been cooled by the applied electric current, heat is applied to the first side of thermoelectric pad 135 that is positioned in thermal contact with first heat exchanger 140. First heat exchanger 140 is therefore heated by the heated first side of thermoelectric pad 135. Heat is conducted into the heat sink fins of first heat exchanger 140 and there radiated into closed system 100 to warm one or more batteries 110. Fan 160 may be used to circulate air that has been heated by heat radiating through the heat sink fins of first heat exchanger 140 throughout closed system 100.

In this manner, heat may be introduced into dosed system 100 to heat one or more batteries 110 within closed system 100. Thermal management system controller 150 continuously receives temperature information for one or more batteries 110 via temperature receiver 155. Once the temperature of one or more batteries 110 within closed system 100 is brought into an optimal range, thermal management system controller 150 adjusts the electric current level applied to thermoelectric pad 135 in order to maintain an optimal temperature environment within closed system 100.

Accordingly, dosed system 100 may be heated when necessary and cooled when necessary by alternating the direction of electric current flowing through thermoelectric pad 135. First heat exchanger 140 and second heat exchanger 145 may then be used to remove heat from closed system 100 or introduce heat to closed system 100 depending on the temperature of one or more batteries 110. In short, thermoelectric pad 135, in combination with first heat exchanger 140 and second heat exchanger 145, may both introduce heat to and remove heat from closed system 100. Thus, the system may be thermally managed to maintain an optimal temperature for one or more batteries 110. extending usable battery life.

In some environments, the climate may be so cold or so hot during portions of the year that batteries may be ruined by overheating or freezing. For example, in many parts of the United States many people connect their combustion engine automobiles to a 120 volt power source to keep their vehicles warm overnight. It is further conceivable that in some climates, it would be desirable to connect a vehicle to an external power source to keep the vehicle cool during the day. In these instances of extreme temperature, thermal management system 130 may be used to maintain an optimal temperature within closed system 100, even when a vehicle is not moving.

Turning again to the example of a hybrid automobile, a vehicle in an extremely hot environment may be connected to an external power source such as AC power, either 120 volts AC or 220 volts AC, depending on the standard in a country in which the hybrid automobile is parked. As the hybrid automobile is parked, the hybrid automobile and the battery pack within the hybrid automobile is heated in the extremely hot environment. In this example, the exemplary battery pack within the hybrid automobile is similar to that of closed system 100, shown in FIG. 1. Thermal management system 130 detects, via thermal management system controller 150 and temperature receiver 155, that the temperature of one or more batteries 110 exceeds an optimal temperature for battery operation and battery life. Thermal management system controller 150 then initiates a cooling sequence for closed system 100. In this example, heat must be removed from dosed system 100. In order to remove the heat, electric current from the external power source is provided to thermal management system 130 because the car is not operating in this example. Thermal management system controller 150 applies electric current provided to thermal management system 130 to thermoelectric pad 135. The electric current provided to thermoelectric pad 135 causes a first side of thermoelectric pad 135 that is positioned to be in thermal contact with first heat exchanger 140 to cool. Heat from closed system 100 is absorbed through heat sink fins on first heat exchanger 140 and conducted to the cooled first side of thermoelectric pad 135. The heat is conducted through thermoelectric pad 135 to a second side of thermoelectric pad 135 that is positioned to be in thermal contact with second heat exchanger 145. In this manner, heat is radiated through the second side of thermoelectric pad 135 into second heat exchanger 145. A thermal fluid within second heat exchanger 145 may simply absorb and dissipate the heat in one embodiment. In another embodiment, electric power from the external power source may cause a pump to circulate thermal liquid through second heat exchanger 145 and thermal unit 165. As the thermal liquid absorbs heat, the heat may be rejected into the air as the temperature of the liquid returns to an equilibrium temperature with the environment. In this manner, an optimal temperature may be maintained within closed system 100 for an extended period of time, even in a very hot climate.

In another example of a hybrid automobile, a vehicle in an extremely cold environment may be plugged in to an external power source such as AC power, either 120 volts AC or 220 volts AC, depending on the standard in a country in which the hybrid automobile is parked. As the hybrid automobile is parked, the hybrid automobile and the battery pack within the hybrid automobile is cooled in the extremely cold environment. In this example, the exemplary battery pack within the hybrid automobile is similar to that of closed system 100, shown in FIG. 1. Thermal management system 130 detects, via thermal management system controller 150 and temperature receiver 155, that the temperature of one or more batteries 110 is lower than an optimal temperature for battery operation and battery life. In response, thermal management system controller 150 initiates a heating sequence for dosed system 100. In this example, heat must be introduced into closed system 100. In order to introduce heat, electric current from the external power source is provided to thermal management system 130 because the car is not operating in this example. Thermal management system controller 150 applies electric current provided to thermal management system 130 to thermoelectric pad 135. The electric current provided to thermoelectric pad 135 causes a first side of thermoelectric pad 135 that is positioned to be in thermal contact with first heat exchanger 140 to warm. Electric current provided to thermoelectric pad 135 such that the first side of thermoelectric pad 135 is heated causes first heat exchanger 140 to absorb heat and radiate that heat into closed system 100. In this example, heat created by thermoelectric pad 135 is sufficient to warm first heat exchanger 140 because of the electric current provided by the external power source. While it is noted that a second side of thermoelectric pad 135 that positioned to be in thermal contact with second heat exchanger 145 will be cooled during this process, such cooling is not necessary for thermal management system 130 to provide heat to closed system 100. Sufficient heat is provided to closed system 100 by thermoelectric pad 135 and first heat exchanger 140.

Accordingly, thermal management system 130 may heat or cool closed system 100 depending on the external environment of closed system 100 and depending on whether or not an external power source is available. It is also advantageous to note that many hybrid automobiles are connected to an external power source to charge the batteries during periods of non-use. Thus, hybrid automobiles in particular are able to easily maintain an optimal temperature for a battery pack because of their ready access to an external power source.

Humidity inside closed system 100 can present a substantial problem. Any moisture in the air can be a proximate or distal cause of a battery shorting, corroding, or overheating. Therefore, in order to maintain the usable life for a battery, humidity must be closely controlled within closed system 100. Thus, in one embodiment, one or more sensors 125 may be a humidity sensor to detect the humidity within closed system 100 and provide humidity information to thermal management system controller 150.

As temperature within closed system 100 is adjusted by being exposed to an external environment or by thermal management system 130, the humidity within closed system 100 can be increased. Accordingly, the rate of heating and cooling according to the foregoing description must be closely managed to prevent humidity from accumulating within closed system 100. For example, if closed system 100 is cold and rapidly heated, condensation could form within closed system 100, which could have a deleterious effect on one or more batteries 110 within closed system 100.

Accordingly, in one embodiment, thermal management system 130 may be configured to slowly adjust the temperature of closed system 100 in order to prevent humidity from condensing and potentially causing damage to one or more batteries 110 within closed system 100. Thermal management system controller 150 may therefore be configured to either selectively apply electric current to thermoelectric pad 135 or reduce the amount of electric current applied to thermoelectric pad 135 to slowly adjust the temperature of closed system 100. However, if condensation is able to form, closed system 100 is provided with one way valve 170 that allows water from condensation to drain out of closed system 100. Housing 120 may be configured to shed water by gravity to a low point within housing 120 where it may be easily drained through one way valve 170.

In another embodiment, thermal management system 130 may be configured to balance the need to charge one or more batteries 110 within closed system 100 with the need for power to supply thermoelectric pad 135 with electric current. For example, thermal management system controller 150 may include a processor programmed to adjust the electric current supplied to thermoelectric pad 135 to charge the battery as fast as possible at an optimal temperature. In other words, thermal management system controller 150 may warm or cool one or more batteries 110 within closed system 100 more slowly in order to charge one or more batteries 110 faster. Thermal management system controller 150 may adjust the heating or cooling rate when a vehicle is in operation or when it is connected to an external power source.

Using the foregoing techniques, closed system 100 provides significant advantages in both battery life and battery efficiency. Such advances substantially improve available range in a hybrid automobile using battery power alone. Furthermore, the electrical draw to cool, heat, or maintain the internal temperature of closed system 100 is quite low, extending the operating range of a hybrid automobile to unprecedented levels.

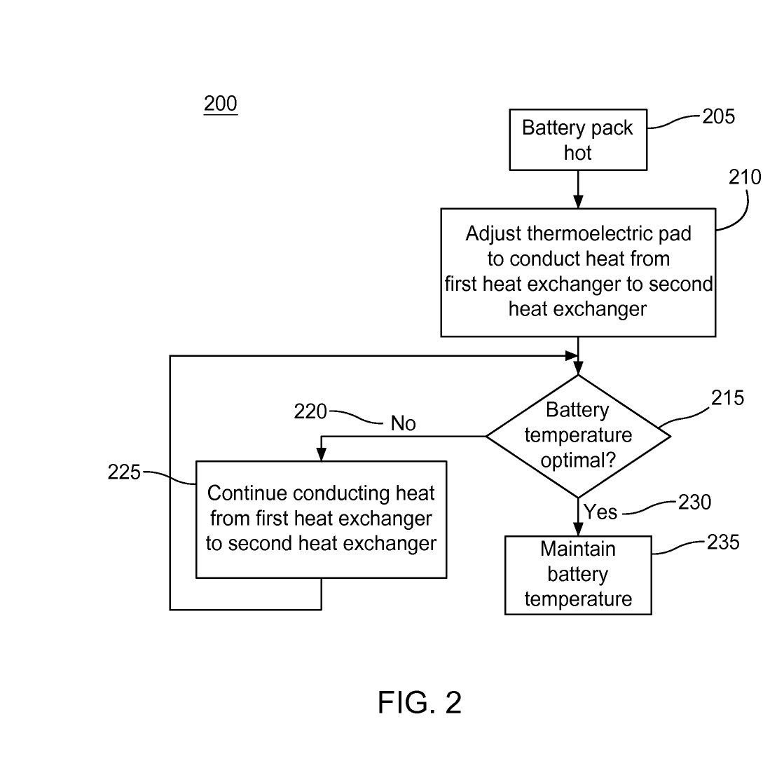

FIG. 2 illustrates a process for cooling a battery subjected to extreme heat to an optimal temperature using the thermal management system. Process 200 begins at step 205, a determination by a thermal management system controller, such as thermal management system controller 150 shown in FIG. 1, that one or more batteries, such as one or more batteries 110 shown in FIG. 1 are hotter than an optimal temperature. In step 210, thermal management system controller 150 adjusts electrical current applied to a thermoelectric pad, such as thermoelectric pad 135 shown in FIG. 1, to conduct heat from a first heat exchanger, such as first heat exchanger 140 shown in FIG. 1, to a second heat exchanger, such as second heat exchanger 145, shown in FIG. 1. Thermal management system controller 150 monitors battery temperature by receiving information from a temperature receiver, such as temperature receiver 155 shown in FIG. 1, and one or more sensors, such as one or more sensors 125, also shown in FIG. 1. At step 215, thermal management system controller 150 determines whether or not the temperature within, for example, closed system 100, is within an optimal range. If the temperature within closed system 100, for example, is outside of an optimal range (Step 220—No), thermal management system controller 150 continues conducting heat from first heat exchanger 140 to second heat exchanger 145 using the techniques described above and as shown in step 225. Thermal management system controller 150 continues monitoring the temperature within closed system 100 (Step 215) and conducting heat out of closed system 100 (Step 225) until thermal management system controller 150 determines that the battery temperature is optimal (Step 230—Yes). Once thermal management system controller 150 has determined that the temperature within closed system 100 is within an optimal range (Step 230—Yes), thermal management system controller 150 may selectively apply electric current to thermoelectric pad 135 or substantially adjust electric current to thermoelectric pad 135 to maintain an optimal battery temperature in step 235.

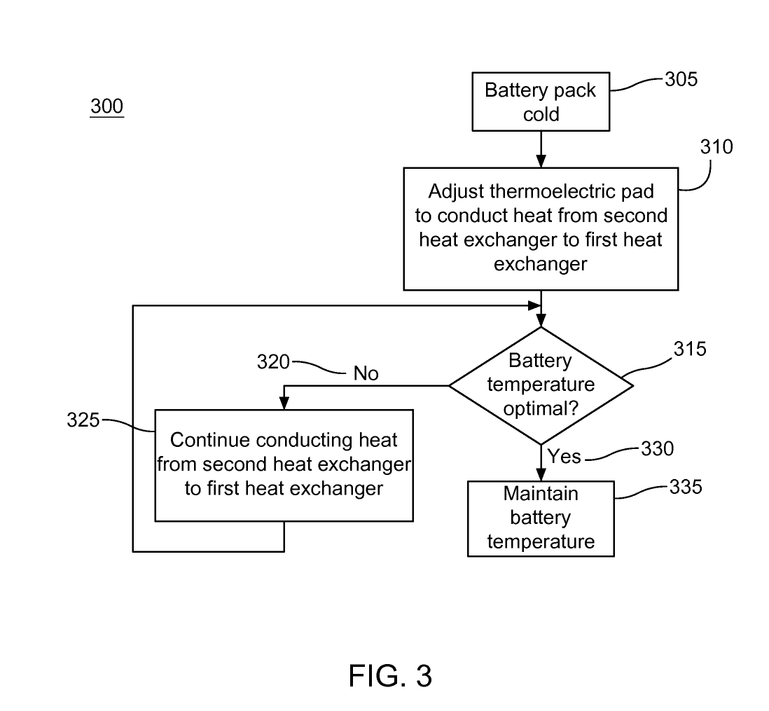

FIG. 3 illustrates a process for warming a battery subjected to extreme cold to an optimal temperature using the thermal management system. Process 300 begins at step 305, a determination by a thermal management system controller, such as thermal management system controller 150 shown in FIG. 1, that one or more batteries, such as one or more batteries 110 shown in FIG. 1 are colder than an optimal temperature. In step 310, thermal management system controller 150 adjusts electrical current applied to a thermoelectric pad, such as thermoelectric pad 135 shown in FIG. 1, to conduct heat from a second heat exchanger, such as second heat exchanger 145 shown in FIG. 1 to a first heat exchanger, such as first heat exchanger 140 shown in FIG. 1. Thermal management system controller 150 monitors battery temperature by receiving information from a temperature receiver, such as temperature receiver 155 shown in FIG. 1, and one or more sensors, such as one or more sensors 125 also shown in FIG. 1. At step 315, thermal management system controller 150 determines whether or not the temperature within, for example, closed system 100, is within an optimal range. If the temperature within closed system 100, for example, is outside of an optimal range (Step 320—No), thermal management system controller 150 continues conducting heat from second heat exchanger 145 to first heat exchanger 140 using the techniques described above and as shown in step 325. Thermal management system controller 150 continues monitoring the temperature within closed system 100 (Step 315) and conducting heat into closed system 100 (Step 325) until thermal management system controller 150 determines, at step 315, that the battery temperature is optimal (Step 330—Yes). Once thermal management system controller 150 has determined that the temperature within closed system 100 is within an optimal range (Step 330—Yes), thermal management system controller 150 may selectively apply electric current to thermoelectric pad 135 or substantially adjust electric current to thermoelectric pad 135 to maintain an optimal battery temperature in step 335.

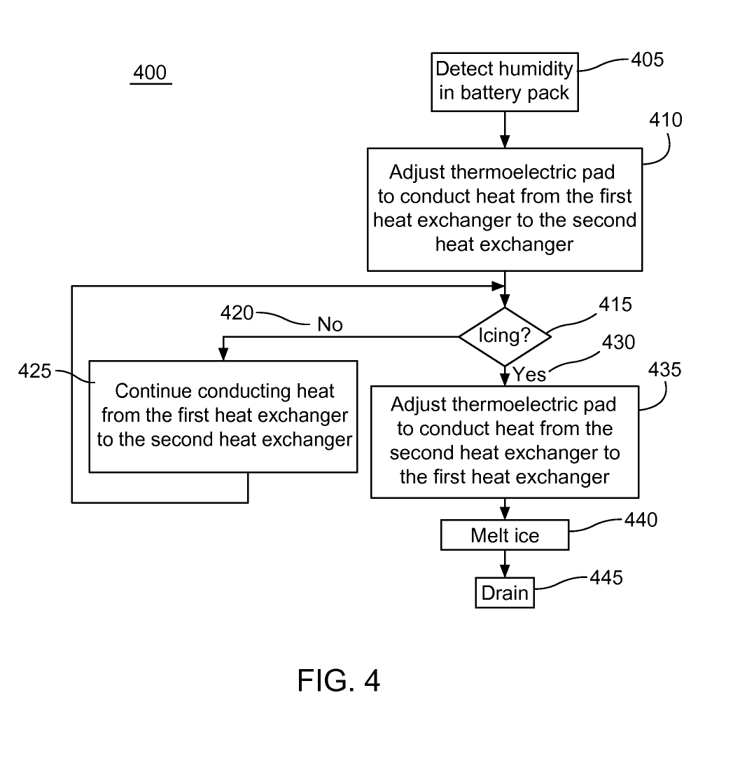

FIG. 4 illustrates a process for removing humidity from a battery pack. Process 400 begins at step 405. a determination by a thermal management system controller, such as thermal management system controller 150 shown in FIG. 1, that humidity exists or exists at a certain level within a closed system, such as closed system 100 shown in FIG. 1. In step 410, thermal management system controller 150 adjusts electrical current applied to a thermoelectric pad, such as thermoelectric pad 135 shown in FIG. 1, to conduct heat from a first heat exchanger, such as first heat exchanger 140 shown in FIG. 1, to a second heat exchanger, such as second heat exchanger 145, shown in FIG. 1. Thermal management system controller 150 monitors humidity within closed system 100 by receiving humidity information from one or more sensors, such as one or more sensors 125, also shown in FIG. 1. At step 415, thermal management system controller 150 monitors battery temperature to determine whether or not ice has formed within closed system 100. Ice forming within closed system 100 indicates that the humidity within closed system 100 has transformed from an airborne state to a frozen state. If ice has not formed within closed system 100 (Step 420—No), thermal management system controller 150 continues conducting heat from first heat exchanger 140 to second heat exchanger 145 as shown in step 425. Thermal management system controller 150 continues monitoring the temperature within closed system 100 (step 415) and conducting heat out of closed system 100 (Step 425) until thermal management system controller 150 determines that ice has formed within closed system 100. Once thermal management system controller 150 has determined that ice has formed within closed system 100 (Step 430—Yes), thermal management system controller 150 adjusts the electric current (i.e., reverses the direction of the flow of electric current) to thermoelectric pad 135 to conduct heat from second heat exchanger 145 to first heat exchanger 140, as shown in step 435. Heat is reintroduced into closed system 100 in a manner that converts the ice to water without reintroducing it to the air. In step 440, the ice melts as heat is applied to first heat exchanger 140 through thermoelectric pad 135. As the ice melts, it is converted to water which is shed through a one way valve, such as one way valve 170 and drained out of closed system 100 in step 445. Humidity is therefore removed from within closed system 100.

In one embodiment, multiple thermoelectric pads, such as one or more of thermoelectric pads 135 shown in FIG. 1, may be implemented in a closed system, such as closed system 100. Multiple thermoelectric pads may provide additional power for heating and cooling closed system 100 as needed for a particular application. Electric current may be selectively applied to each thermoelectric pad such that a hot side of one thermoelectric pad is positioned in thermal contact with a cold side of another thermoelectric pad. Alternatively, multiple first heat exchangers, such as one or more of first heat exchanger 140 shown in FIG. 1 and multiple second heat exchangers, such as one or more of second heat exchanger 145 shown in FIG. 1 may be implemented with multiple thermoelectric pads as may suit a particular application. For example, in some implementations, such as airplanes or spacecraft, the power of multiple thermoelectric pads may be necessary to counteract the extreme temperatures of high altitude or outer space.

The foregoing description has been presented for purposes of illustration. It is not exhaustive and does not limit the invention to the precise forms or embodiments disclosed. Modifications and adaptations will be apparent to those skilled in the art from consideration of the specification and practice of the disclosed embodiments. For example, components described herein may be removed and other components added without departing from the scope or spirit of the embodiments disclosed herein or the appended claims.

Other embodiments will be apparent to those skilled in the art from consideration of the specification and practice of the disclosure disclosed herein. It is intended that the specification and examples be considered as exemplary only, with a true scope and spirit of the invention being indicated by the following claims.

What is claimed is:

1. A system comprising:
a first heat exchanger,
a second heat exchanger, and
a thermoelectric pad in thermal contact with the first heat exchanger and the second heat exchanger and positioned between the first heat exchanger and the second heat exchanger.

2. The system of claim 1, wherein
the thermoelectric pad conducts heat from the first heat exchanger to the second heat exchanger.

3. The system of claim 1, wherein the thermoelectric pad conducts heat from the second heat exchanger to the first heat exchanger.

4. The system of claim 2, wherein a direction of an electric current applied to the thermoelectric pad initiates conduction of heat from the first heat exchanger to the second heat exchanger.

5. The system of claim 3, wherein a direction of an electric current applied to the thermoelectric pad initiates conduction of heat from the second heat exchanger to the first heat exchanger.

6. The system of claim 1, further comprising:
one or more batteries disposed within a sealed housing.

7. The system of claim 6, wherein the first heat exchanger, the thermoelectric pad, and the second heat exchanger are disposed with the one or more batteries within the sealed housing.

8. The system of claim 1, wherein the first heat exchanger includes one or more heat sink fins.

9. The system of claim 6, further comprising:
a thermal management system controller disposed within the sealed housing and that applies electric current to the thermoelectric pad in one of a first direction and a second direction.

10. The system of claim 9, further comprising:
one or more sensors that provide at least one of temperature information and humidity information to the thermal management system controller.

11. The system of claim 9, wherein the thermal management system controller adjusts at least one of a temperature and a humidity level within the sealed housing by applying electric current to the thermoelectric pad in one of the first direction and the second direction.

12. A system, comprising:
a first heat exchanger disposed within a housing,
a second heat exchanger disposed within the housing,
a thermoelectric pad in thermal contact with the first heat exchanger and the second heat exchanger and positioned between the first heat exchanger and the second heat exchanger within the housing, and
a substrate within the housing,
wherein the temperature of the housing is controlled by a thermal management system controller applying electric current to the thermoelectric pad.

13. The system of claim 12, further comprising:
at least one temperature sensor associated with the substrate.

14. The system of claim 13, further comprising:
a temperature information receiver that receives temperature information from the at least one temperature sensor associated with the substrate.

15. The system of claim 12, wherein the thermal management system controller controls a rate of at least one of heat conduction into the housing and heat conduction out of the housing.

16. The system of claim 15, wherein the thermal management system controller controls the rate of at least one of heat conduction into the housing and heat conduction out of the housing by selectively applying electric current to the thermoelectric pad.

17. The system of claim 15, wherein the thermal management system controller controls the rate of at least one of heat conduction into the housing and heat conduction out of the housing by reducing the electric current applied to the thermoelectric pad.

18. The system of claim 12, further comprising:
a one way valve disposed in the housing.

19. The system of claim 12, further comprising:
at least one humidity sensor associated with the housing.

20. The system of claim 19, wherein a humidity level within the housing is adjusted at least in part by the thermal management system controller applying electric current to the thermoelectric pad.
